(19) United States
(12) Patent Application Publication
(10) Pub. No.: US 2004/0165859 A1
(43) Pub. Date: Aug. 26, 2004

(54) Article and method for selective hydrogen loading of optical fibers

(75) Inventors: Mokhtar S. Maklad, Woodbury, MN (US); Melinda M. Ice-Anderson, Forest Lake, MN (US)

Correspondence Address: CARLSON, CASPERS, VANDENBURGH & LINDQUIST, 225 SO. 6TH STREET, SUITE 3200, MPIS, MN, 55402, US

(73) Assignee: ADC Telecommunications, Inc., Eden Prairie, MN

(21) Appl. No.: 10/656,932

(22) Filed: Sep. 5, 2003

Related U.S. Application Data
(60) Provisional application No. 60/408,745, filed on Sep. 6, 2002.

(51) Int. Cl. G02B 6/00

(52) U.S. Cl. 385/147

(57) ABSTRACT

A device and method for selectively hydrogen loading one or more portions of an optical fiber is described. The device includes a housing that defines a first optical fiber port, a second optical fiber port, a chamber within the housing extending from the first optical fiber port to the second optical fiber port to receive the portion of the at least one optical fiber, a hydrogen input port, and a hydrogen channel extending from the hydrogen input port to a portion of the chamber. A portion of an optical fiber is disposed in the chamber. Hydrogen is introduced into the chamber through a hydrogen channel defined by the housing. The hydrogen is then loaded into the portion of the optical fiber within the chamber.

### FIELD OF THE INVENTION

This invention relates to methods and articles for loading hydrogen into optical fibers. In addition, the invention relates to methods and articles for loading hydrogen into selective portions of optical fibers.

### BACKGROUND OF THE INVENTION

A variety of devices can be formed in optical fibers by taking advantage of the fiber photosensitivity. In particular, useful structures, such as Bragg gratings, can be formed by inducing an index modulation in the optical fiber core, cladding, or both. This modulation can be produced by exposing the fiber to ultraviolet laser light, for example 248 nm light, using a phase mask or two interfering laser beams in a holographic configuration. The formation of such structures in an optical fiber can take a substantial amount of time. It is known however, that the diffusion of hydrogen into the optical fiber core can increase the photosensitivity of the optical fiber to the ultraviolet light. This permits faster formation of a structure, thereby avoiding or reducing problems such as long laser exposure time and the possibility that vibration or motion during the procedure could alter or mask the desired structure.

It is believed the hydrogen that diffuses into the core of the optical fiber forms hydroxyl groups within the optical fiber. Using current techniques, the entire optical fiber is typically placed in a heated and pressurized hydrogen atmosphere at a pressure of 2,000 to 7,000 psi (about 14 MPa to 49 MPa) and a temperature ranging from about 72° C.-100° C. for periods that can run from one to ten days. The optical fiber is then exposed to UV (ultraviolet) light to produce a modulated refractive index structure, such as a Bragg grating. This process often requires a heating or annealing step after generating the modulated refractive index structure. This heating or annealing typically results in the elimination of the unstable part of the refractive index modulation, thus giving the resulting grating a long useful service time.

The conventional processes for loading hydrogen into optical fibers can be wasteful, because hydrogen is loaded into substantially all of the optical fiber. The Bragg grating or other photo-induced structure is typically produced in only a small section of the fiber. In addition, the optical fiber may be connected, subsequent to hydrogen loading, to another device, such as a solid state laser. Many devices are hermetically sealed to prevent the introduction of contaminants into the device. In particular, laser devices are hermetically sealed to reduce contamination which can be detrimental to the operation and lifetime of the laser. A portion of the optical fiber typically extends into the laser housing for optical coupling. Operation of the laser typically results in heating of the laser and optical fiber. This can release hydrogen gas from the hydrogen treated optical fiber and contaminate the components within the laser.

### SUMMARY OF THE INVENTION

Generally, the present invention relates to an article and method for selectively hydrogen loading one or more portions of an optical fiber. One embodiment is an article to selectively expose a portion of at least one optical fiber to hydrogen. The article includes a housing that defines a chamber. The housing has at least a first optical fiber port coupled to the chamber to receive the portion of the at least one optical fiber. The housing also includes a hydrogen input port, and a hydrogen channel extending from the hydrogen input port to the chamber.

Another embodiment of the invention is a method of loading hydrogen into a selected portion of an optical fiber. The method includes disposing the selected portion of the optical fiber in a chamber defined by a housing. Hydrogen is maintained in the chamber so that the hydrogen loads into the selected portion of the optical fiber in the chamber.

The above summary of the present invention is not intended to describe each disclosed embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic cross-sectional side view of an article to selectively expose a portion of at least one optical fiber to high pressure hydrogen, according to an embodiment of the invention;

FIG. 2A is a schematic top view of a plug for use with the article of FIG. 1, according to an embodiment of the invention;

FIG. 2B is a schematic cross-sectional side view of the plug of FIG. 2A, according to an embodiment of the invention; and

FIG. 3 is a schematic cross-sectional side view of the article of FIG. 1 including plugs and end caps, with optical fibers disposed in the article, according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention is believed to be applicable to methods and articles for loading hydrogen into optical fibers. In particular, the present invention is directed to methods and articles for loading hydrogen into selected portions of optical fibers. While the present invention is not so limited, an appreciation of various aspects of the invention will be gained through a discussion of the examples provided below.

Some articles of the present invention include a housing having a chamber that contains a portion of one or more optical fibers. The one or more fibers pass from the chamber through at least one of the ends of the housing to the outside environment. The housing ends are sealed to prevent, reduce, restrict, or otherwise inhibit the flow of hydrogen out of the chamber. A hydrogen channel allows for the flow of hydrogen into the chamber to allow the diffusion of hydrogen into the portions of the optical fibers contained within the chamber. This device facilitates the selective loading of hydrogen into only the portion of an optical fiber located between the two ends of the chamber. This device can facilitate the incorporation of hydrogen into only those regions where photo-induced structures, such as Bragg gratings, are to be formed. This restricts the hydrogen loading to a small length of the fiber and reduces the amount of hydrogen that is needed to load the optical fiber. The untreated end or ends of the fiber are available for connecting to hermetically sealed devices, without introducing hydrogen contamination. This method and device can also limit the region of the optical fiber from which hydrogen can later diffuse, thereby preventing or reducing the diffusion of hydrogen into other devices to which the optical fiber is attached, such as solid state lasers.

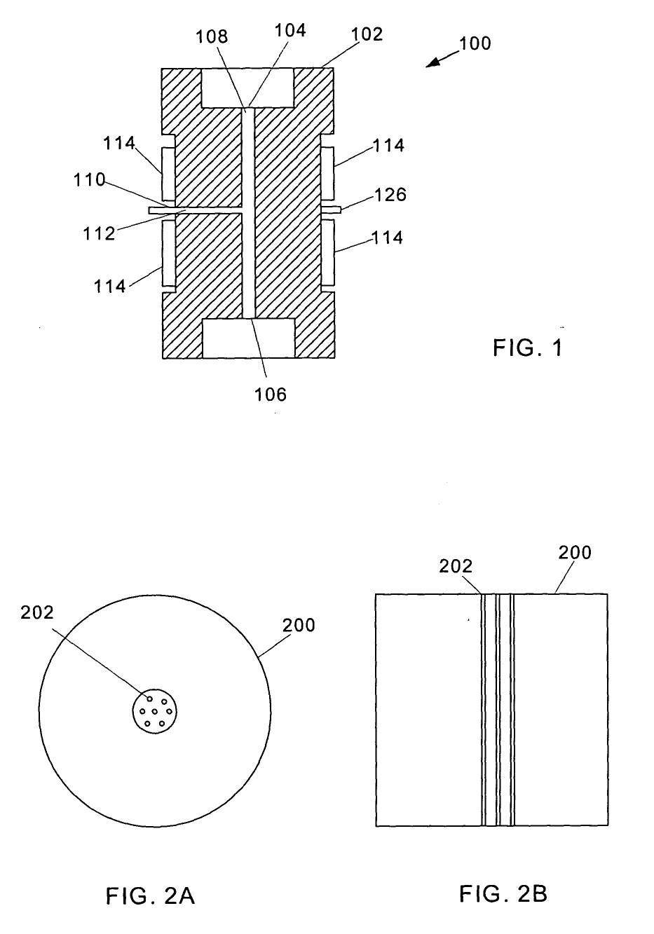

FIGS. 1, 2A, 2B, and 3 illustrate one particular embodiment of the device 100, according to the invention. The device 100 includes a housing 102 that defines a first optical fiber port 104, a second optical fiber port 106, and a high pressure diffusion chamber 108. The two optical fiber ports 104 and 106 are coupled to the chamber 108. In the illustrated embodiment, the chamber 108 extends between the two optical fiber ports 104 and 108. The housing 102 also includes a hydrogen input port 110, and a hydrogen channel 112 extending from the hydrogen input port 110 and in communication with the chamber 108.

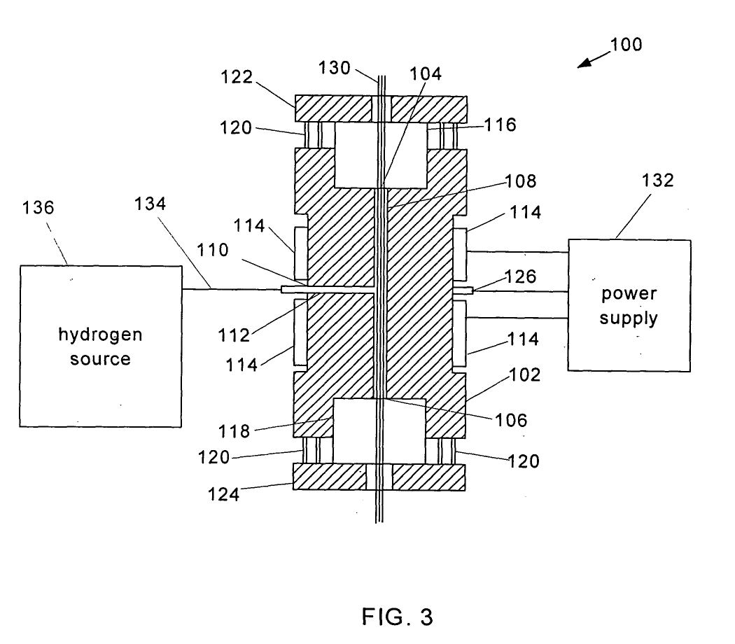

In addition, as illustrated in FIG. 3, the device 100 includes first and second ends 116 and 118 to seal the ends of the chamber 108, and thus prevent, reduce, restrict, or otherwise inhibit hydrogen from escaping from the chamber 108. The ends 116 and 118 may be in the form of plugs. Holding devices, such as first and second end caps 122 and 124 and restraining members 120, may be used to hold the ends 116 and 118 in place to seal the ends of the chamber 108. The device 100 may optionally include a heating element 114, for example contacted to at least a portion of the housing, to provide heat and increase the hydrogen loading rate in the chamber 108. The device 100 may also have an optional temperature sensor 126 attached to the housing 102 to monitor the temperature produced by the heating element 114.

The housing 102 holds the optical fibers and provides an enclosed space, the chamber 108, which may also be referred to as an optical fiber channel or gas plenum, for high pressure hydrogen gas to diffuse into those portions of one or more optical fibers 130 contained within the chamber 108. This configuration may be used to restrict the length of the optical fiber(s) 130 exposed to hydrogen gas. This restricted length of fiber may be the region where the photo-induced structure (e.g., Bragg grating) will be formed. The housing 102 may have any shape that provides the chamber 108 with at least a first optical fiber port, and typically also a second optical fiber port, and a hydrogen channel. The optical fiber ports refer to those portions through which the optical fiber passes between the chamber 108 and the outside environment. The housing 102 of the illustrated embodiment is generally cylindrical, but other shapes may also be used. The housing 102 may also include optional end flanges that extend radially outward beyond the cylindrical barrel defined by a center portion of the housing. The optional end flanges may be used for the attachment of the first and second end caps 122,124.

The housing 102 may be formed using any material and thickness that provides sufficient stability to withstand the pressures and temperatures of the hydrogen loading process and which preferably has low permeability to hydrogen. Preferably, the housing 102 may be reused many times. In addition, the material of the housing is preferably not substantially degraded by extended contact with hydrogen at the temperatures and pressures used in the loading process. The housing may be fabricated, for example, from a metal such as 316 or 304 stainless steel. Hydrogen may cause embrittlement in standard steel compositions. Generally, the material of the housing 102 is also selected to provide good thermal transfer of energy from the heating element 114 or other heat source to the chamber 108.

The housing 102 can be molded or machined to form the first or second optical fiber ports 104, 106, the chamber 108, the hydrogen input port 110 and the hydrogen channel 112. The sizes of the first or second optical fiber ports 104, 106 and the chamber 108 are generally selected to allow the passage of one or more optical fibers 130. Typically, the first and second optical fiber ports 104, 106 and the chamber 108 have sizes that are substantially larger than the one or more optical fibers so that the optical fibers 130 may be isolated from each other and from the chamber wall. The length of the chamber 108 roughly corresponds to the length of the optical fiber to be hydrogen loaded. Preferably, this length is no more than 50%, 25%, 10%, or even 1% of the total length of the optical fiber. In some embodiments, the length of the chamber is in the range of 5 to 25 cm. Longer or shorter chambers can be used, however, if desired.

The first and second optical fiber ports 104, 106 are formed with a depth and width suitable for seating the ends 116, 118. Preferably, the first and second ends 116, 118 can be snugly seated within the first and second optical fiber ports 104, 106 by sliding the first and second ends 116, 118 into the respective first and second optical fiber ports 104, 106.

The hydrogen input port 110 and hydrogen channel 112 can be selected to have a size that provides sufficient flow of hydrogen to attain the desired hydrogen pressure within the chamber 108. The hydrogen input port 110 can optionally have a connector that extends from the housing for attachment to a hydrogen supply line 134. The hydrogen supply line 134 may be slid over the connector. In another embodiment, the connector may have a locking or other attachment mechanism that is used in conjunction with a complementary connector on the hydrogen supply line to mechanically lock the hydrogen supply line onto the connector and that can withstand the hydrogen pressure. The hydrogen supply line 134 is coupled to a hydrogen source 136.

The first and second ends 116, 118 are provided to prevent, reduce, restrict, or otherwise inhibit the flow of hydrogen out of the chamber 108. In addition, the first and second ends 116, 118 may be used to hold two or more optical fibers 130 in a spaced apart arrangement to permit hydrogen flow to all surface areas of the optical fibers 130 and to prevent or reduce any damage that might occur due to contact with the inner walls of the housing or other optical fibers or the heating of the optical fibers. FIGS. 2A and 2B illustrate one embodiment of an end 200, that includes one or more optical fiber channels 202 through which individual optical fibers can be drawn. Where there are two or more optical fiber channels 202, the channels 202 are typically spaced apart from each other. The spatial configuration of these channels 202 may be any regular or irregular configuration that spaces the fibers 130 apart to permit hydrogen flow to the fiber surfaces. The channels 202 typically have the same or slightly larger diameter than the optical fibers that are to be drawn through the chamber. For example, where the optical fiber 130 has an external diameter of 250 μm, the channel 202 may have a diameter of 275 μm channels can be used for 250 μm optical fibers. The channels 202 may be formed by machining or molding the end.

The ends 116, 118 can be formed using any material which can substantially prevent, resist, reduce, or otherwise inhibit the flow of hydrogen out of the chamber 108. In one embodiment, the ends 116, 118 are plugs formed using an elastomeric material that is compressible. Examples of silicone elastomeric materials include silicone or silastic, such as GE RTV 615 and GE RTV 630, available from General Electric Company. Elastomeric materials are particularly useful because pressure can be applied against the ends 116, 118 by the end caps 120, 122 to compress the ends 116, 118, causing the plug material to deform, expanding and filling the first and second optical fiber ports 104, 106. This may also form a seal around the optical fibers 130 in the optical fiber channels 202. Preferably, the material of the ends 116 and 118 is resistant to degradation when heated to the temperatures used during the hydrogen loading process and is also resistant to contact with hydrogen at the process temperatures and pressures. However, should degradation occur, the ends 116, 118 may be replaced. The ends 116, 118 may be routinely replaced after a number of hydrogen loading cycles or after a particular amount of time.

In operation, pressure may be applied to the ends 116, 118 using the end caps 122, 124 by tightening the restraining members 120 or otherwise pushing the end caps 122, 124 along the restraining members 120. The end caps 122, 124 generally have a surface area that, when in position, makes contact with and can be used to compress the ends 116, 118. The one or more restraining members 120 are typically used to apply pressure to the ends 116, 118 via the end caps 122, 124 and to hold the end caps 122, 124 in place and provide uniform pressure throughout the outer periphery of the ends 116, 118. Examples of suitable restraining members 120 include screws, nuts and bolts, and clamps that can be tightened to apply pressure to the ends 116, 118 via the end caps 122, 124. The end caps 122, 124 can be made of any suitable materials including those used for the housing 102, such as metals, plastics and the like. It will be recognized that other methods and mechanisms can be used to apply pressure to and, if the ends are deformable, deform the plugs 116, 118.

Typically, the portions of the optical fiber(s) 130 within the device 100 are raised to an elevated temperature during the hydrogen loading cycle so that hydrogen diffusion into the optical fiber(s) 130 is increased. A variety of different methods may be used to heat the portions of the optical fiber(s) 130 within the device 100. For example, the entire device 100 may be placed in an oven and heated to the desired temperature. Another method includes heating the housing 102 using a heating device 114 disposed on or in the housing 102. The heating device 114 may be a suitable, known heating device including, for example, heating tape, heating cartridges, RF heating elements, and heating coils. The heating device 114 may be placed around any part of the housing 102. Where the heating device 114 is wrappable around the housing 114, for example the heating device 114 is heating tape or a heating coil, the heating device 114 is advantageously wrapped around at least a portion of the center section of the housing 102 for uniform heating of the housing 102. A power source 130, such as an electrical power supply, may be coupled to provide power to the heating device 114. The power source 130 can typically provide a variable amount of power so that the temperature of the housing 102 can be adjusted; however, this is not necessary for the practice of every embodiment of the invention.

Optionally, a temperature sensor 126, for example, a thermocouple, thermistor or other known temperature sensor, may be provided to monitor the temperature. For example, the temperature sensor 126 may be in contact with the housing 102 or within the chamber 108. The temperature sensor 126 may be used in conjunction with the heating device 114 or with an oven. The power source 132 may be coupled to the temperature sensor 126 to modify the amount of heat provided by the heating device 114 as measured by the temperature sensor 126. For example, the power source 132 may be used to maintain, increase, or decrease the temperature. In some embodiments, the temperature controller may also be used to modify the temperature according to a desired time and temperature schedule. Typically, the temperature at which hydrogen loading is performed is in the range of 70° C. to 100° C.; however, higher or lower temperatures may also be used. In some embodiments, the temperature at which hydrogen loading is performed is in the range of 70° C. to 80° C.

The heating device 114 may also be a fluid coil for delivering heat to the housing 102 by flowing a hot fluid, such as hot water, through the coil. In such a case, the power source 132 is a source of heated fluid and may include, for example, a hot water heater and a pump.

As hydrogen diffusion of the optical fiber(s) is performed at high pressure and relatively low temperature, a large concentration of hydrogen can diffuse into the optical fiber in molecular form, without forming —OH bonds. Subsequent exposure to heat or to UV light is believed to trigger a chemical reaction between hydrogen and the optical fiber, forming, for example, GeOH, SiOH, GeH, SiH and oxygen deficient centers (E' centers), depending on the particular wavelength of UV light used and/or the heat exposure conditions. This is described in general in Atkins, et al., J. AppI. Phys., 75, 344-348 (1992); Atkins, et al., Electron. Lett., 29, 1234-1235 (1993); and Greene, et al., J. Non-Cryst. Solids, 168, 195-199 (1994), all of which are incorporated herein by reference.

The pressure of hydrogen to be used in hydrogen loading the optical fibers 130 in the device 100 depends on a variety of factors including the desired hydrogen concentration within the optical fiber, the time during which the loading is performed, and the temperature at which the loading is performed. Typically, the hydrogen pressure is in the range of 2,000 to 7,000 psi (about 14 to 50 MPa); however, higher or lower hydrogen pressures may also be used. In at least some embodiments the pressure is 2,000 to 3,000 psi (about 14 to 21 MPa).

As an example of operation, one or more optical fibers 130 are threaded through one of the ends 116, then through the chamber 108 of the housing 102 and then through the other end 118. Alternatively, the optical fiber(s) 130 may be disposed in the chamber 108 and the ends 116, 118 are then threaded over the fiber(s). The ends 116, 118 are then positioned over or at least partially within the first and second optical fiber ports 104, 106, respectively. In some embodiments, hydrogen gas can be flowing prior to compressing the sealing the ends 116, 118 at the first and second optical fiber ports 104, 106. This can be done to purge the chamber 108 of other gases. In other embodiments, hydrogen gas does not flow into the device until after the ends are positioned at the first and second optical fiber ports. In this case, the chamber 108 may be evacuated, for example through an evacuation port (not shown), prior to filling the chamber 108 with hydrogen gas.

The end caps 122, 124 are fastened to the housing 102 using the restraining members 120. The end caps 122, 124 are tightened to provide a pressure against the first and second ends 116, 118 to cause the ends to deform, if they are elastomeric, and substantially prevent, resist, reduce, or otherwise inhibit the flow of hydrogen gas out of the chamber 108 and to seal the optical fibers 130 within the ends. A hydrogen supply line is attached at the hydrogen input port 110. Hydrogen gas is supplied to the optical fiber channel 108 through the hydrogen input port 110 and hydrogen channel 112 to achieve the desired hydrogen pressure in the chamber 108. The housing 102 is typically heated to the desired temperature using the heating element 114 or any other heating method or apparatus. The loading of hydrogen at the desired temperature and pressure continues for a period of time to provide the desired level of hydrogen diffusion. The period of time typically depends on the type of optical fiber, the pressure of hydrogen gas, and the temperature of the optical fibers within the device. For example, the period of time can be one to two days and may be one week or longer. After the desired hydrogen loading is achieved, the optical fibers are removed from the device.

It will be appreciated that the fiber may pass into and/or out of the chamber through only one end of the chamber, and the other end of the chamber may be unopenable. In such a case, there only one plug is typically needed to seal the chamber. The same fiber may pass through the plug once, if the fiber end is being diffused with hydrogen, or at least twice, if a section of the fiber away from the fiber end is being diffused.

A photo-induced structure, such as a Bragg grating, may then be formed in the portion of the optical fiber in which hydrogen has been loaded using any known technique, such as those described above. The portion of the optical fiber can then be heated or annealed to remove the unstable part of the photo-induced refractive index modulation and reduce the amount of hydrogen gas that will later be released from the optical fiber.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A device for selectively exposing a portion of at least one optical fiber to hydrogen, the article comprising:
a housing defining a chamber, the housing having at least a first optical fiber port coupled to the chamber to receive the portion of the at least one optical fiber, the housing also including a hydrogen input port, and a hydrogen channel extending from the hydrogen input port to the chamber.

2. The device of claim 1, further comprising at least a first sealed end at the first optical fiber port to permit the at least one optical fiber to pass out of the chamber to outside the housing while resisting flow of gas from the chamber to outside the housing.

3. The device of claim 2, wherein the first sealed end includes a first plug, the first plug defining at least one optical fiber passage, each optical fiber passage being configured and arranged to hold at least one optical fiber, the first plug being configured and arranged so that at least a portion of the first plug fits over the first optical fiber port to resist the flow of gas out of the first optical fiber port.

4. The device of claim 3, wherein the first plug comprises a compressible material.

5. The device of claim 3, wherein the first plug defines a plurality of optical fiber passages through the first plug.

6. The device of claim 3, further comprising a first end cap, wherein the first end cap applies pressure against the first plug to facilitate the first plug resisting the flow of gas out of the first optical fiber port.

7. The device of claim 6, wherein the first plug is formed of a compressible material that is deformed by applying pressure from the first end cap to increase a resistance to the flow of gas out of the first optical fiber port.

8. The device of claim 2, further comprising a second optical fiber port and a second sealed end at the second optical fiber port to permit the at least one optical fiber to pass out of the chamber to outside the housing while resisting flow of gas from the chamber to outside the housing.

9. The device of claim 8, wherein the second sealed end includes a second plug, defining at least one optical fiber passage, each optical fiber passage being configured and arranged to hold at least one optical fiber, the second plug being configured and arranged so that at least a portion of the second plug fits over the second optical fiber port to resist the flow of gas out of the second optical fiber port.

10. The device of claim 1, further comprising a heating element disposed over a portion of the housing to heat the portion of the at least one optical fiber disposed within the chamber.

11. The device of claim 10, further comprising a temperature sensor disposed on the housing.

12. The device of claim 1, further comprising a connector extending from the hydrogen input port to provide for connection to a hydrogen supply line.

13. The device of claim 12, further comprising a hydrogen supply coupled to the connector.

14. A method of loading hydrogen into a selected portion of an optical fiber, the method comprising:
disposing the selected portion of the optical fiber in a chamber defined by a housing; and
maintaining hydrogen in the chamber so that the hydrogen loads into the selected portion of the optical fiber in the chamber.

15. The method of claim 14, wherein maintaining the hydrogen in the chamber includes introducing the hydrogen to the chamber via a hydrogen channel defined by the housing and communicating with the chamber.

16. The method of claim 14, further comprising heating the selected portion of the optical fiber while maintaining the hydrogen in the chamber.

17. The method of claim 16, wherein heating the selected portion of the optical fiber comprises positioning a heating device in thermal contact with at least a portion of an exterior of the housing and heating the portion of the exterior of the housing using the heating device.

18. The method of claim 16, further comprising monitoring a temperature while maintaining hydrogen in the chamber using a temperature sensor coupled to measure temperature of one of the housing and an interior of the housing.

19. The method of claim 18, further comprising modifying a temperature of the selected portion of the optical fiber based on the monitored temperature.

20. The method of claim 19, wherein monitoring the temperature includes monitoring a temperature of an exterior surface of the housing and modifying the temperature of the selected portion of the optical fiber includes modifying heat applied to the housing.

21. The method of claim 14, wherein the chamber extends between first and second optical fiber ports defined by the housing and the method further comprises positioning first and second ends over the first and second optical fiber ports, respectively, to reduce leakage of hydrogen from the optical fiber channel through the first and second optical fiber ports.

22. The method of claim 21, wherein the first and second ends comprise at least one optical fiber passage, the optical fiber is one fiber of one or more optical fibers and the method further comprises
threading the one or more optical fibers through one or more of the at least one optical fiber passage of the first end; and
threading the one or more optical fibers through one or more of the at least one optical fiber passage of the second end so that the portion of the optical fiber is disposed in the chamber.

23. The method of claim 21, further comprising applying pressure against the first and second ends to further reduce leakage of hydrogen through the first and second optical fiber ports.

24. The method of claim 23, further comprising seating at least a portion of the first and second ends into the first and second optical fiber ports.

25. The method of claim 24, wherein the first and second ends comprise a compressable material and wherein applying pressure against the first and second ends comprises applying pressure against the first and second ends to compress the first and second ends to further conform the seated portions of the first and second end to the first and second optical fiber ports.

26. A system for loading hydrogen into a selected portion of an optical fiber, the method comprising:
means for disposing the selected portion of the optical fiber in a chamber defined by a housing; and
means for maintaining hydrogen in the chamber so that the hydrogen loads into the selected portion of the optical fiber in the chamber.
